(19) United States
(12) Patent Application Publication
(10) Pub. No.: US 2009/0245234 A1
(43) Pub. Date: Oct. 1, 2009

(54) DYNAMIC REROUTING OF VOIP SESSIONS

(75) Inventors: Sriram Parameswar, Snoqualmie, WA (US); Avronil Bhattacharjee, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/059,603

(22) Filed: Mar. 31, 2008

(51) Int. Cl. H04L 12/66

(52) U.S. Cl. 370/352

(57) ABSTRACT

Network connections that are used in routing VoIP session to their end destination are monitored to determine when a call fails to reach its destination. When a network failure is detected, the call is automatically routed to another device that is not dependent on the failed network connection. The call may be automatically rerouted to one or more secondary numbers, such as a mobile telephone number and/or a PSTN number.

### BACKGROUND

Reliable telephone communication is important to businesses. Public Switched Telephone Networks (PSTNs) are typically very reliable but require businesses to deploy expensive Private Branch Exchange (PBX)-type appliances which also require provisioning and maintenance. As a result, businesses are integrating Voice over Internet Protocol (VoIP) technology into their telephony infrastructure, thereby eliminating the need for expensive network overhauls. VoIP connections at this point in time, however, are not as reliable as cellular or PSTN connections.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

IP PBXs are typically deployed in centralized locations typically network operations centers (NOCs) tied to the enterprise. Incoming calls from the PSTN and IP networks are routed to their respective branch office destinations. IP network connections that are used in routing calls to their end destination (typically branch offices) are monitored proactively to determine if incoming sessions will be routed successfully. When a network failure is detected, the call is dynamically routed to another device that is not dependent on the failed network connection. The call may be automatically rerouted to one or more secondary numbers that are associated with the destination on the VoIP network, such as a mobile telephone number and/or a PSTN number.

### BRIEF DESCRIPTION OF THE DRAWINGS

FIG. 1 illustrates an exemplary computing environment;

FIG. 2 shows a communications system for automatically rerouting a VoIP Session; and

FIG. 3 shows an illustrative process for automatically rerouting a call.

### DETAILED DESCRIPTION

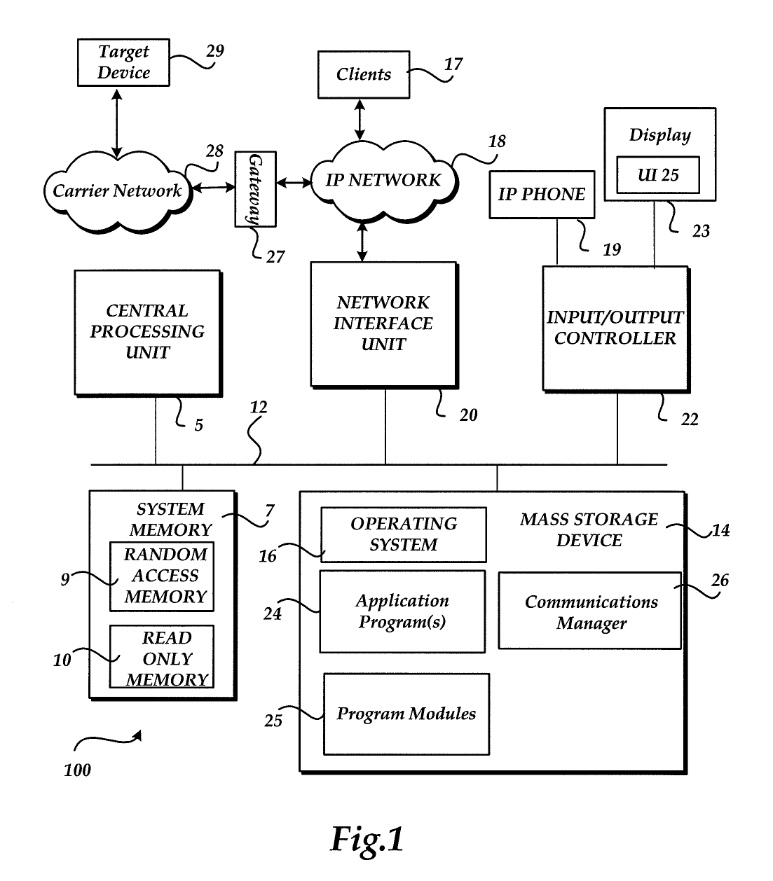

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application program(s) 24, other program modules 25, and communication manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to an IP phone 19, a display screen 23, a printer, or other type of output device.

Carrier network 28 is a network responsible for communicating with target devices 29, which may be both PSTN phones or Mobile Devices. The carrier network 28 may include both wireless and wired components. For example, carrier network 28 may include a cellular tower that is linked to a wired telephone network. Typically, the cellular tower carries communication to and from mobile devices, such as cell phones, notebooks, pocket PCs, long-distance communication links, and the like.

Gateway 27 routes messages between carrier network 28 and IP Network 18. For example, communications manager 26 may reroute a call directed to a client on IP network 18 to a mobile device on carrier network 28 when a network failure is detected. Gateway 27 provides a means for transporting the communication from the IP network to the carrier network. Conversely, a user with a device connected to a carrier network may be directing a call to a client on IP network 18.

As mentioned briefly above, a number of program modules and data files may be stored in the mass storage device 14 and RAM 9 of the computer 100, including an operating system 16 suitable for controlling the operation of a computer, such as WINDOWS SERVER® or the WINDOWS VISTA® operating system from MICROSOFT CORPORATION of Redmond, Wash. The mass storage device 14 and RAM 9 may also store one or more program modules. In particular, the mass storage device 14 and the RAM 9 may store one or more application programs 24 and program modules 25. Generally, communications manager 26 is configured to monitor network connections that are used in routing calls to their end destination, determine proactively or when a call fails to reach its destination on the IP network, and automatically reroute the call based on the cost. When a network failure is detected, a database is consulted that sets up the alternate routing based on current costs and the call is automatically routed to another device that is not dependent on the failed network connection. The call may be automatically rerouted to one or more secondary numbers, such as a mobile telephone number on a cellular carrier network and/or a PSTN number (a landline phone). User Interface 25 may be utilized to associate the secondary number(s) with the destination on the IP network.

According to one embodiment, communications manager 26 communicates with an application such as MICROSOFT's OFFICE COMMUNICATOR®. While communications manager 26 is illustrated as an independent program, the functionality may be integrated into other software and/or hardware. The operation of communications manager 26 is described in more detail below.

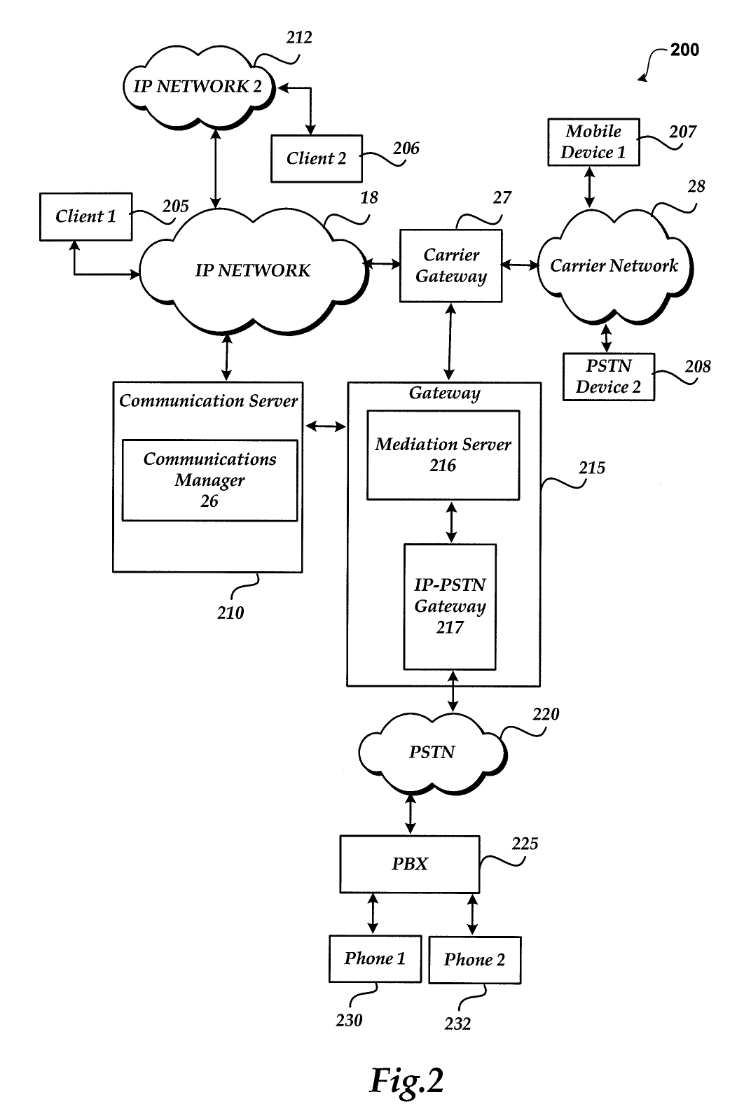

FIG. 2 shows a communications system for automatically rerouting a VoIP session. As illustrated, system 200 includes client 1 (205) that is coupled to IP Network 18, client 2 (206) that is coupled to IP Network 2 (212), mobile device 1 (207) and PSTN device 2 (208) that are coupled to carrier network 28, communication server 210 including communications manager 26, carrier gateway 27, gateway 215, mediation server 216, IP-PSTN gateway 217 coupled to PBX 225 through PSTN 220 and phone 1 (230) and phone 2 (232).

The communications server 210 and communications manager 26 are configured to route incoming calls to the appropriate destinations and automatically reroute the incoming calls to alternate destinations when a network failure is detected. According to one embodiment, routing settings that are configured on a client device determines how to route the incoming calls. For example, a client device may specify what number(s) to call when an incoming call is directed to one or more of the client's telephone numbers. Routing communication within system 200 may be done different ways. For example, a telephone number may be mapped to a Session Initiation Protocol (SIP) Uniform Resource Indicator (URI) using a Reverse Number Lookup (RNL) process. By performing reverse number lookup, the server 210 can route calls to endpoints associated with a particular user's SIP Uniform Resource Identifier (URI). The server may also utilize call authorization rules configured by an administrator to route each call to the appropriate media gateway (i.e. carrier gateway 27, IP-PSTN gateway 217). According to one embodiment, communications server 210 utilizes SIP. For more information on this industry standard protocol see IETF RFC 3261 which may be found at http://www.ietf.org/rfc/rfc3261.txt. Generally, SIP defines a standard for session setup, termination, and media negotiation between two parties that is widely used for Voice-over-IP (VoIP) call signaling.

Organizations that conduct business in more than one geographic location require some way to translate identical phone number strings into numbers that are valid for each location. A traditional Private Branch Exchange (PBX) maintains separate numbering plans for each location. When a PBX system receives a call to a particular user extension, there is no ambiguity about the appropriate destination since the PBX system is configured only for the site where it is deployed. Using an Enterprise Voice infrastructure, however, is quite different. Unlike the site-specific PBX infrastructure, the Enterprise Voice infrastructure is distributed across the enterprise network. In an Enterprise Voice distributed infrastructure, location profiles may be used to create a dialing experience similar to site-specific PBX infrastructures in which a number string is translated according to the locale from which it is dialed. A location profile is a named set of normalization rules that translate phone numbers for a named location to a single standard (E.164) format for purposes of phone authorization and call routing. The normalization rules define how phone numbers expressed in various formats will be routed for the named location. The same number string may be interpreted and translated differently depending on the locale from which it is dialed.

The communication server 210 using communications manager 26 routes calls to endpoints on the IP network (IP-IP calls); routes calls to the public switched telephone network (PSTN)/PBX (IP-PSTN calls) and may also route calls to destinations using other networks, such as a carrier network. The communication server may be coupled to the networks through one or more gateways. A gateway translates signaling and media between the network and the IP voice infrastructure. The gateway 215 may be composed of one or more devices. For example, the gateway 215 may be implemented as a mediation server 216 and an IP-PSTN gateway 217 or the functionality of the mediation server and the IP-PSTN may be included within the gateway as illustrated. Generally, IP-PSTN gateway 217 is a gateway that is located between a landline phone (i.e. phone 1 or phone 2) and any SIP User Agent Client (i.e. client 1 or client 2). Gateway 217 allows a person to call any (allowed) telephone number from any SIP-compliant client application.

Mediation Server 216 provides signaling and media translation between the VoIP infrastructure and a gateway. Mediation Server 216 also links the Communication Server 210, such as Microsoft's Office Communications Server 2007®, with a PBX 225. On the communications server side, the media server 216 listens on a mutual TLS transport address. TLS (Transport Layer Security), is a protocol for establishing a secure connection between a client and a server. TLS (Transport Layer Security) is capable of authenticating both the client and the server and creating a encrypted connection between the two. The TLS (Transport Layer Security) protocol is extensible, meaning that new algorithms can be added for any of these purposes, as long as both the server and the client are aware of the new algorithms. On the gateway side, mediation server listens on a single TCP/IP transport address. Generally, the mediation server 216 is configured for: translating SIP over TCP (on the gateway side) to SIP over mutual TLS (on the Enterprise Voice side); encrypting and decrypting SRTP (Secure Real-time Transport Protocol) on the communications server side; translating media streams between the communications server and the gateway; connecting clients that are outside the network to internal ICE (Interactive Connectivity Establishment) components, which enable media traversal of NAT and firewalls; and acting as an intermediary for call flows that a gateway does not support, such as calls from remote workers on an enterprise voice client.

As discussed, communications server 210 is configured to provide communication services for one or more locations. For example, communications server 210 may be utilized for a business having branch offices that are connected using IP Network 18 and/or other IP networks (e.g. IP Network 2 (212)). For example, Client 2 may be located at a branch office while communication server 210 is located at the main office. Communications manager 26 is configured to help maintain communication with the branch offices in case of a loss of one or more network links that prevent communications with the branch clients (i.e. Client 2) from the main office (i.e. server 210). Direct Inward Dialing (DID) numbers and direct calls that reach communications manager 26 that are destined for a branch office are routed over one or more IP networks, such as a Wide Area Network (WAN) link to reach the client at a branch office. The Communications manager 26 proactively checks the connections with its various branch offices and may decide to invoke alternative cost based routing when failure is detected. When a call is routed from communications manager 26, the network connection(s) used in routing the call is monitored to determine if the call fails to reach its destination. According to one embodiment, the network connections to the branch offices are monitored periodically to determine if a connection still exists. For example, communication server 210 may implement a heartbeat probe with one or more computing devices at each branch office thereby keeping a check on branch office connectivity. When a certain number of heartbeat probes fail between the communication server and the branch office, the network connection for this connections is marked as having a link failure. According to another embodiment, after the call is routed, a determination is made as to whether an acknowledgement message is received in response to sending the call to the destination. If the acknowledgment is not received, then a network failure is detected. When a network failure is detected, the call is automatically routed to another device that is associated with the client at the branch office that is not dependent on the failed network connection. For example, the call may be automatically rerouted to one or more secondary numbers that are associated with the client, such as a mobile telephone number and/or a PSTN number. According to one embodiment, for each dynamic re-routing of the call a cost matrix is consulted to ensure that the re-routing happens along the least expensive route.

The following examples are provided to illustrate the effects of losing network connectivity in a branch office with the main office. The examples are for illustration purposes only, and are not intended to be limiting. Suppose that a branch office sales team is waiting on a customer call to confirm a large order when it loses network connectivity (suppose that IP network 2 goes down) to the IP PBX deployed at the main office of the business. The customer call to the default branch office number is received at the main office on communications server 210. Upon routing the call the branch office, the communications manager 26 recognizes the loss of the connectivity to the branch office and automatically routes the call to one or more mobile phones and/or landlines in the branch office. For example, instead of routing the call to Client 2 on the IP network, the call is routed to mobile device 1 that is associated with the sales team at the branch office. Instead of the call not going through to the branch office (if it wasn't rerouted) due to the network failure, a member of the sales team answers the call, and is able to confirm the order.

In another example, suppose that the branch office has several divisions. Each division designates primary and secondary contact numbers in case of network disruption. During one episode of network disruption, the customer call destined for one of the divisions is routed from communication server 210 to both the primary and secondary contact numbers designated by that division. As can be seen by the above examples, when a network failure is recognized, the call is automatically routed to other devices that are not affected by the failure of the network connection.

According to another embodiment, landline numbers at a branch office may be automatically mapped to mobile numbers to reduce the price of a call. For example, in some countries, tariffs for landline to mobile calls are more expensive than landline to landline calls. By mapping the landline numbers to mobile numbers, customers calling an enterprise are not made liable for the higher charges due to the increased tariffs.

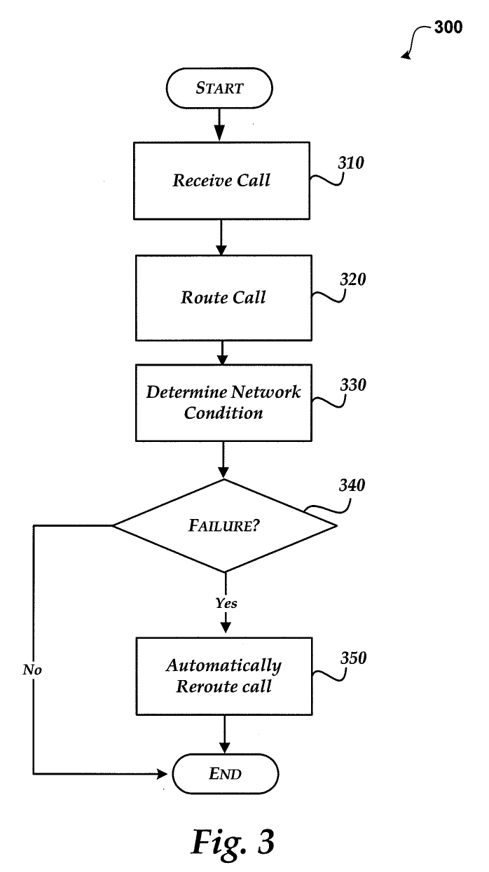

Referring now to FIG. 3, an illustrative process 300 for automatically rerouting a VoIP session will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 310, where a call is received. According to one embodiment, the call is received by a communications server that is coupled to offices at other destinations using IP network connections.

Moving to operation 320, the call is routed to its destination. Call routing rules may specify to route a call to one or more different destinations, such as one or more IP phones on an IP network.

Flowing to operation 330, the condition of the network is determined. As discussed above, the condition of the network may be determined many different ways. The network may be monitored continuously, periodically and/or the condition of the network may be determined from whether or not the call reaches its destination on the IP network.

Transitioning to decision operation 340, a determination is made as to whether the network has a failure condition that prevents the call from reaching its destination on the IP network. When the network condition has not failed, then the process proceeds to an end operation. When the network has a failure condition, the process moves to operation 350.

At operation 350, the call is automatically rerouted to another destination. According to one embodiment, this is based on least-cost as determined by a cost matrix, that does not utilize the network having the failure condition. According to one embodiment, the call is routed to one or more mobile phone numbers and/or a landline(s) that is associated with the destination. The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for automatically rerouting a VoIP session, comprising:
receiving an incoming call at a communications server;
routing the incoming call to a primary destination on an IP network;
automatically detecting when a network failure occurs that prevents the call from reaching its primary destination on the IP network; and
automatically rerouting the call to a secondary destination that is not on the IP network when the network failure is detected; wherein the automatic rerouting includes using a least expensive route.

2. The method of claim 1, further comprising receiving a designation of the secondary destination that is utilized in case of network failure that is associated with the primary destination.

3. The method of claim 1, wherein rerouting the call comprises rerouting the call to a mobile telephone number.

4. The method of claim 1, wherein rerouting the call comprises rerouting the call to a landline telephone number on a PSTN.

5. The method of claim 1, wherein automatically detecting when the network failure occurs that prevents the call from reaching its primary destination comprises determining when a response to routing the incoming call to the primary destination is not received by the communications server within a predetermined period of time.

6. The method of claim 1, wherein automatically detecting when the network failure occurs that prevents the call from reaching its primary destination comprises periodically probing the IP network and determining when a number of responses to the probes do not return to the communications server.

7. The method of claim 1, further comprising automatically mapping landline numbers to mobile telephone numbers.

8. A computer-readable storage medium having computer-executable instructions for automatically rerouting a VoIP session, comprising:
receiving an incoming call at a communications server; wherein the call is destined for a primary destination on an IP network;
routing the incoming call to the primary destination on an IP network;
monitoring the IP network to determine when a network failure occurs; wherein the network failure prevents the call to reach its primary destination; and
automatically rerouting the call to a secondary destination that is not on the IP network when the network failure occurs.

9. The computer-readable storage medium of claim 8, further comprising designating more than one secondary destination for the primary destination.

10. The computer-readable storage medium of claim 8, wherein automatically rerouting the call comprises rerouting the call comprises consulting a cost matrix to determine a least expensive route.

11. The computer-readable storage medium of claim 8, wherein automatically rerouting the call comprises rerouting the call to at least one landline telephone number on a PSTN and at least one mobile telephone number.

12. The computer-readable storage medium of claim 8, wherein monitoring the IP network comprises determining when a response to routing the incoming call to the primary destination is not received by the communications server within a predetermined period of time or the call has failed to reach its primary destination after a predetermined period of time has elapsed.

13. The computer-readable storage medium of claim 8, wherein monitoring the IP network comprises periodically probing one or more devices on the IP network and determining when a number of responses from the one or more devices do not return to the communications server.

14. A system for automatically rerouting a VoIP session, comprising:
a data store that is configured to store a secondary number that is associated with a primary number; wherein the secondary number is utilized when an IP network that is associated with the primary number is disrupted such that the primary number is unreachable;
a network connection that is configured to connect to the IP network;
a processor and a computer-readable medium;
an operating environment stored on the computer-readable medium and executing on the processor; and
a communications manager operating under the control of the operating environment and operative to:
receive an incoming call;
determine a primary number to route the incoming call on the IP network;
route the incoming call to the primary number on the IP network;
automatically monitor the IP network to determine when the call is unable to reach the primary number on the IP network; and
automatically rerouting the call to the secondary number that is not on the IP network.

15. The system of claim 14, wherein the communications manager is hosted at a different location from a location that is associated with the primary number.

16. The system of claim 14, wherein automatically rerouting the call comprises rerouting the call to a mobile telephone number.

17. The system of claim 14, wherein automatically rerouting the call comprises rerouting the call to a landline telephone number on a PSTN.

18. The system of claim 14, wherein automatically monitoring the IP network comprises determining when a response to routing the incoming call to the primary number is not received within a predetermined period of time.

19. The system of claim 14, wherein automatically monitoring the IP network comprises periodically probing devices on the IP network and determining when a number of responses from the devices in response to the probes do not return.

20. The system of claim 14, wherein the IP network is a WAN connection linking a main office with a branch office.
